(19) United States
(12) Patent Application Publication
(10) Pub. No.: US 2015/0193911 A1
(43) Pub. Date: Jul. 9, 2015

(54) DISPLAY CONTROL DEVICE, DISPLAY CONTROL SYSTEM, AND DISPLAY CONTROL METHOD

(71) Applicant: SONY CORPORATION, Tokyo (JP)

(72) Inventors: Daisuke Mochizuki, Chiba (JP); Yuki Okamura, Saitama (JP); Takaomi Kimura, Tokyo (JP)

(73) Assignee: SONY CORPORATION, Tokyo (JP)

(21) Appl. No.: 14/410,786

(22) PCT Filed: Jul. 1, 2013
(86) PCT No.: PCT/JP2013/068072

§ 371 Date: Dec. 23, 2014

(30) Foreign Application Priority Data
Aug. 27, 2012 (JP) 2012-187027

(51) Int. Cl. G06T 3/40; G06F 3/14

(52) U.S. Cl. CPC G06T 3/4092; G06F 3/1415; G06T 3/4038

(57) ABSTRACT

Provided is a display control device, including a display control section that displays a plurality of images in a display section in time series in accordance with a plurality of pieces of effect information set for the plurality of images, an aspect ratio determination section that determines an aspect ratio of the display section, and an effect information selection section that selects, from the plurality of pieces of effect information set for respective aspect ratios, a piece of the effect information corresponding to the aspect ratio of the display section as effect information for use in display of the plurality of images.

### TECHNICAL FIELD

The present invention relates to a display control device, a display control system, and a display control method.

### BACKGROUND ART

Provision of a slideshow in which a plurality of images are continuously displayed is a general method for browsing images in a terminal device. Regarding this slideshow, various technologies are proposed. For example, Patent Literature 1 discloses a technology for, by setting an aspect ratio at a time of playing slideshow in advance, allowing a user to confirm, on a display screen, which part of an image is cut out in accordance with the aspect ratio. Patent Literature 2 discloses a technology for, when an image is cut out to provide a slideshow, cutting out a more appropriate region by detecting a focused region. Patent Literature 3 discloses a technology in which, when an image is displayed in a display region whose aspect ratio is different from that of an original image, whether a whole image is displayed with a blank space or a part of the image is displayed without a blank space is changed depending on a condition, and, when the part of the image is displayed, the whole image is displayed by scrolling.

Patent Literature 4 discloses a technology for editing a slideshow in real time during play of the slideshow. The slideshow herein is a slideshow based on a scenario file. In the scenario file, a display timing of an image, a display position of the image, a zoom ratio, and the like are designated. In the technology disclosed in Patent Literature 4, operations related to individual images defined by the above scenario file are directly designated. Patent Literature 5 describes a technology for editing an image, such as rotation and cutting out of the image, during play of a slideshow.

### CITATION LIST

### Patent Literature

Patent Literature 1: JP 2012-23472A

Patent Literature 2: JP 2011-53296A

Patent Literature 3: JP 4592099B

Patent Literature 4: JP 2010-256488A

Patent Literature 5: JP 2010-172009A

### SUMMARY OF INVENTION

### Technical Problem

However, in recent years, opportunities in which a user brows images are further increased, and therefore it is required to display a more appropriate image in accordance with a situation in which a user brows an image. In view of this, the present disclosure proposes novel and improved display control device, display control system, and display control method capable of displaying a more appropriate image in accordance with a situation in which a user brows an image.

### Solution to Problem

According to the present disclosure, there is provided a display control device, including a display control section that displays a plurality of images in a display section in time series in accordance with a plurality of pieces of effect information set for the plurality of images, an aspect ratio determination section that determines an aspect ratio of the display section, and an effect information selection section that selects, from the plurality of pieces of effect information set for respective aspect ratios, a piece of the effect information corresponding to the aspect ratio of the display section as effect information for use in display of the plurality of images.

Further, according to the present disclosure, there is provided a display control system, including a terminal device that displays a plurality of images in a display section in time series in accordance with a plurality of pieces of effect information set for the plurality of images, and a server that generates the plurality of pieces of effect information for respective aspect ratios and provides the plurality of pieces of effect information to the terminal device. The terminal device determines an aspect ratio of the display section and selects, from the plurality of pieces of effect information set for the respective aspect ratios, a piece of the effect information corresponding to the aspect ratio of the display section as effect information for use in display of the plurality of images.

Further, according to the present disclosure, there is provided a display control method, including displaying a plurality of images in a display section in time series in accordance with a plurality of pieces of effect information set for the plurality of images, determining an aspect ratio of the display section, and selecting, from the plurality of pieces of effect information set for respective aspect ratios, a piece of the effect information corresponding to the aspect ratio of the display section as effect information for use in display of the plurality of images.

### Advantageous Effects of Invention

According to the present disclosure as described above, it is possible to display a more appropriate image in accordance with a situation in which a user brows an image.

### BRIEF DESCRIPTION OF DRAWINGS

FIG. 1 is an illustration of a schematic functional configuration of a terminal device according to a first embodiment of the present disclosure.

FIG. 2 is an illustration of a schematic functional configuration of a system according to a second embodiment of the present disclosure.

FIG. 3 is an illustration of a schematic functional configuration of a terminal device according to a third embodiment of the present disclosure.

FIG. 4 is an illustration of an example of effect information in an embodiment of the present disclosure.

FIG. 5 is an illustration of another example of effect information in an embodiment of the present disclosure.

FIG. 6 is an illustration for describing an example of a change in a display region of an image in an embodiment of the present disclosure.

FIG. 7 is an illustration for describing an example of a change in a display region of an image in an embodiment of the present disclosure.

FIG. 8 is an illustration for describing an example of a change in a display region of an image in an embodiment of the present disclosure.

FIG. 9 is an illustration for describing an example of a change in a display region of an image in an embodiment of the present disclosure.

FIG. 10 is an illustration for describing an example of a change in display positions of images in an embodiment of the present disclosure.

FIG. 11 is an illustration for describing an example of a change in display positions of images in an embodiment of the present disclosure.

FIG. 12 is an illustration for describing an example of a change in display positions of images in an embodiment of the present disclosure.

FIG. 13 is an illustration for describing an example of a change in display positions of images in an embodiment of the present disclosure.

FIG. 14 is an illustration for describing an example of a change in animation of images in an embodiment of the present disclosure.

FIG. 15 is an illustration for describing an example of a change in animation of images in an embodiment of the present disclosure.

FIG. 16 is an illustration for describing an example of a change in animation of images in an embodiment of the present disclosure.

FIG. 17 is an illustration for describing an example of a change in animation of images in an embodiment of the present disclosure.

FIG. 18 is an illustration of a further display example in an embodiment of the present disclosure.

FIG. 19 is an illustration of a further display example in an embodiment of the present disclosure.

FIG. 20 is an illustration for describing a first example of determination of an aspect ratio in an embodiment of the present disclosure.

FIG. 21 is an illustration for describing a second example of determination of an aspect ratio in an embodiment of the present disclosure.

FIG. 22 is an illustration for describing a third example of determination of an aspect ratio in an embodiment of the present disclosure.

FIG. 23 is an illustration of an example of correction of effect information in an embodiment of the present disclosure.

FIG. 24 is an illustration of an example where effect information in an embodiment of the present disclosure is changed in response to an operation performed by a user.

FIG. 25 is an illustration of an example where positions of images are changed in the same example of FIG. 24.

FIG. 26 is an illustration of an example where a representative image in an embodiment of the present disclosure is changed in response to an operation performed by a user.

FIG. 27 is an example of a user interface in the example of FIG. 26.

FIG. 28 is a block diagram for describing a hardware configuration of an information processing apparatus.

### DESCRIPTION OF EMBODIMENTS

Hereinafter, preferred embodiments of the present invention will be described in detail with reference to the appended drawings. Note that, in this specification and the drawings, elements that have substantially the same function and structure are denoted with the same reference signs, and repeated explanation is omitted.

Note that description will be made in the following order.

1. Embodiment regarding Configuration of Device
1-1. First Embodiment
1-2. Second Embodiment
1-3. Third Embodiment

2. Example of Effect Information

3. Display Example
3-1. Example of Change in Display Region
3-2. Example of Change in Display Position
3-3. Example of Change in Animation

4. Example of Determination of Aspect Ratio

5. Example of Correction/Change

6. Hardware Configuration

7. Supplementary Explanation

### 1. Embodiment Regarding Configuration of Device

### 1-1. First Embodiment

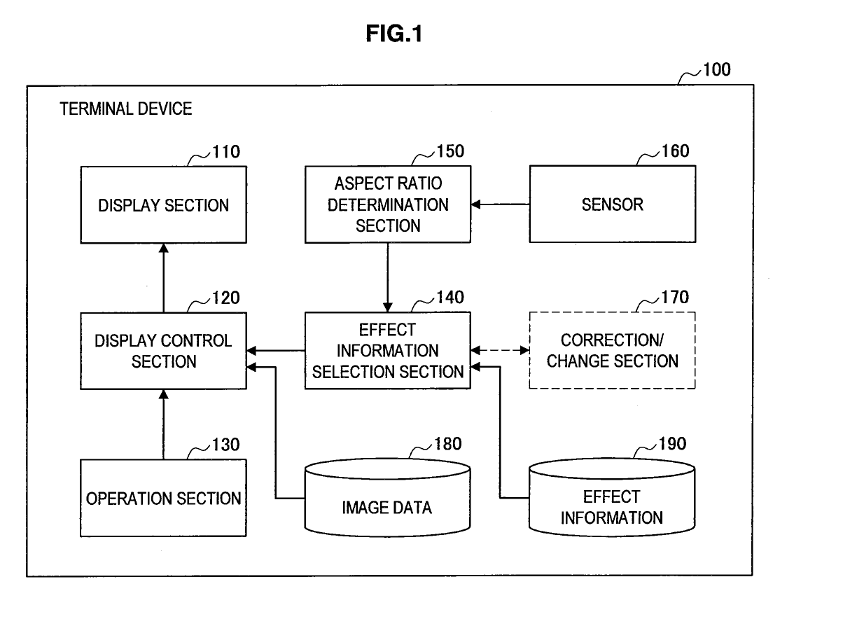

FIG. 1 is an illustration of a schematic functional configuration of a terminal device according to a first embodiment of the present disclosure. In FIG. 1, a terminal device 100 includes a display section 110, a display control section 120, an operation section 130, an effect information selection section 140, an aspect ratio determination section 150, and a sensor 160. The terminal device 100 may additionally include a correction/change section 170. The terminal device 100 can use image data 180 and effect information 190. Those kinds of information may be stored in the terminal device 100 or may be acquired from a storage on a network as necessary.

The terminal device 100 encompasses various types of personal computers (PC), mobile phones (including smartphones), media players, game consoles, and the like, and is realized by, for example, a hardware configuration of an information processing apparatus described below. The terminal device 100 can appropriately include not only the illustrated functional configuration but also functional configurations for input and output, network communication, and the like.

The display section 110 displays various types of information including an image toward a user in accordance with control of the display control section 120. The display control section 120 controls display of the display section 110 in response to operation input by a user acquired via the operation section 130. In this embodiment, the display control section 120 displays a plurality of images in the display section 110 in time series in accordance with the effect information 190 set for the respective images. Display of the plurality of images in time series herein can be display referred to also as “slideshow” in general. The display control section 120 acquires the image data 180 for use in display of the images and uses a piece of the effect information 190 that the effect information selection section 140 has selected.

The effect information selection section 140 selects, from the plurality of pieces of effect information 190, the piece of the effect information that the display control section 120 uses to display the images. Herein, the effect information selection section 140 selects the piece of the effect information 190 corresponding to an aspect ratio of the display section 110 determined by the aspect ratio determination section 150. That is, the plurality of pieces of effect information 190 are set for respective expected aspect ratios of the display section, and the effect information selection section 140 selects, from the plurality of pieces of the effect information 190, the piece of the effect information suitable for the aspect ratio of the display section 110. The effect information can include, for example, information that defines a trimmed region in a case where each image is displayed in the display section, a moving direction or a moving speed in a case where each image is displayed in the display section, a display position of each image in the display section, and the like.

The aspect ratio determination section 150 determines an aspect ratio of the display section 110 on the basis of a detection result of the sensor 160. In the aspect ratio detected herein, whether the display section is vertically long or laterally long, such as 4:3 and 3:4, is discriminated. In this embodiment, for example, a holding direction of a housing of the terminal device 100 is detected by the sensor 160 which is an acceleration sensor, and, based on the holding direction, the aspect ratio determination section 150 determines the aspect ratio of the display section 110. For example, in a case where the display section 110 is a screen having the aspect ratio of 4:3 and the housing is held in a vertically long direction, the aspect ratio determination section 150 determines that the aspect ratio of the display section 110 is width:length=3:4. Meanwhile, in a case where the housing is held in a laterally long direction, the aspect ratio determination section 150 determines that the aspect ratio of the display section 110 is width:length=4:3.

Note that the aspect ratio determination section 150 may determine not only aspect ratios having an inverse relationship as in the above example but also aspect ratios having different ratios. For example, the aspect ratio determination section 150 may determine whether the aspect ratio of the display section 110 is 4:3 or 16:9. Such a difference in ratio can be determined on the basis of information on, for example, a size (such as a pixel ratio of length to width) of the display section 110 that the terminal device 100 retains as setting information.

The correction/change section 170 is additionally provided and provides a part or all of the following functions. For example, in a case where there is a difference between an aspect ratio corresponding to the effect information set in advance and the aspect ratio of the display section 110, the correction/change section 170 corrects effect information corresponding to an aspect ratio closest to the aspect ratio of the display section 110 on the basis of the difference between the aspect ratio corresponding to the effect information and the aspect ratio of the display section 110, thereby providing more appropriate effect information. Further, for example, in a case where the display control section 120 changes display of an image in response to an operation performed by a user with respect to the image displayed in the display section 110, the correction/change section 170 may change information on each image defined in the effect information in accordance with the change of the display. Furthermore, for example, in a case where the display control section 120 displays images as a group in the display section 110, the correction/change section 170 may change a representative image of the group in response to an operation performed by a user.

### 1-2. Second Embodiment

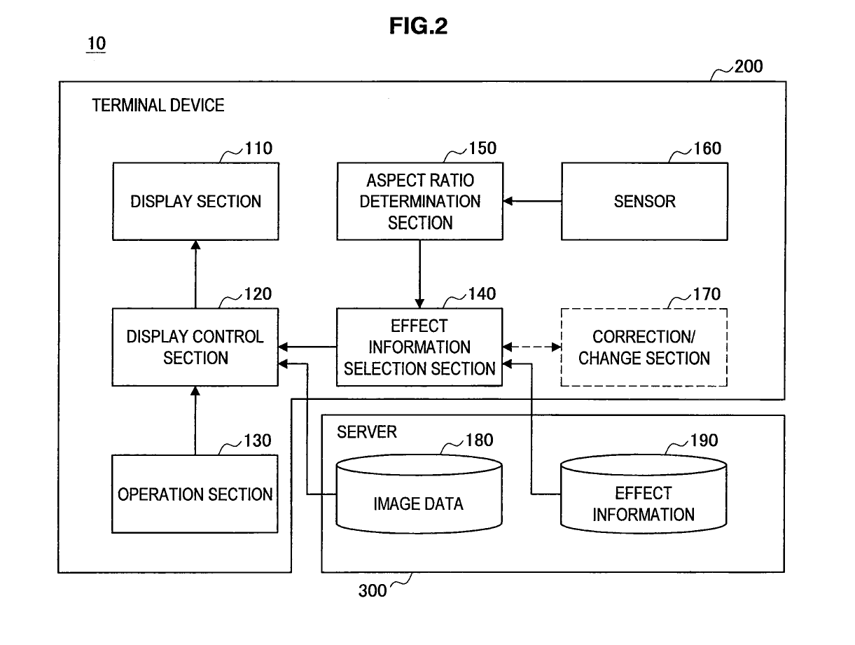

FIG. 2 is an illustration of a schematic functional configuration of a system according to a second embodiment of the present disclosure. In FIG. 2, a system 10 includes a terminal device 200 and a server 300. The terminal device 200 can be realized in the same way as the terminal device 100 of the first embodiment. The server 300 is an aggregate of functions realized by a server device of a terminal or cooperation of a plurality of server devices connected via various wired or wireless networks. Each server device is realized by a hardware configuration of, for example, the information processing apparatus described below. The each server device can include not only the illustrated functional configuration but also functional configurations for input and output, network communication, and the like as appropriate. The terminal device 200 and the server 300 are connected via various wired or wireless networks.

The terminal device 200 and the server 300 realize a function similar to that of the terminal device 100 of the first embodiment as a whole. That is, the terminal device 200 displays a plurality of images on a display section in time series on the basis of effect information set for the respective images. The server 300 generates the plurality of pieces of effect information for respective aspect ratios of the display section and provides the effect information to the terminal device 200. Herein, the terminal device 200 determines the aspect ratio of the display section 110 and selects, from the plurality of pieces of effect information set for the respective aspect ratios, a piece of the effect information corresponding to the aspect ratio of the display section 110 as effect information for use in display of the images.

As described in the example of this embodiment, each functional configuration described in embodiments of the present disclosure herein may be realized in a terminal device or may be realized in a server. Therefore, embodiments of the present disclosure are not limited to the first embodiment and the second embodiment described above, and various embodiments in which respective functions are realized by distributed terminal device and server can be employed.

### 1-3. Third Embodiment

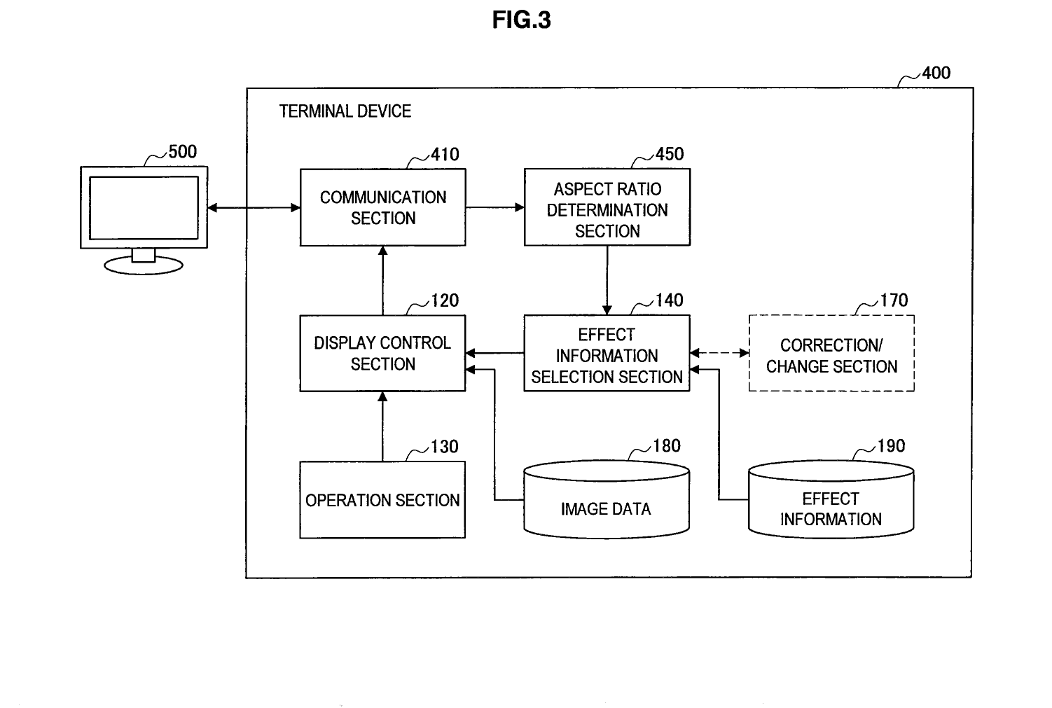

FIG. 3 is an illustration of a schematic functional configuration of a terminal device according to a third embodiment of the present disclosure. In FIG. 3, a terminal device 400 includes, as a function different from that of the terminal device 100 of the first embodiment, a communication section 410 and an aspect ratio determination section 450. The terminal device 400 displays various types of information including an image in a display device 500 connected via various wired or wireless networks. Therefore, in this case, the display control section 120 displays an image in a display section of the display device 500 via the communication section 410. The aspect ratio determination section 450 acquires information from the display device 500 via the communication section 410, and, based on the information, determines an aspect ratio of the display section of the display device 500.

As described above, the terminal device according to the embodiment of the present disclosure may display an image in an external device and may be a device that does not include a display section. Alternatively, the terminal device may display an image in a display section of the external device instead of or along with a display section included in the terminal device. Note that, also in this embodiment, a modification example in which a functional configuration of the terminal device is realized by a server can be employed as in the first and second embodiments.

### 2. Example of Effect Information

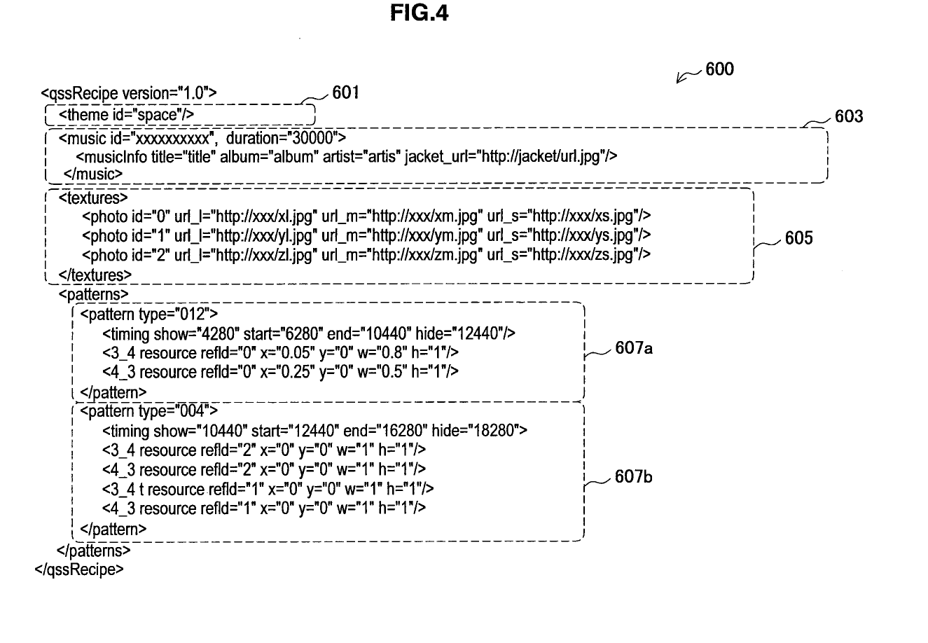

FIG. 4 is an illustration of an example of effect information in an embodiment of the present disclosure. The effect information 600 includes, for example, a theme ID 601, music information 603, resource information 605, and effect pattern information 607.

The theme ID 601 is an ID for comprehensively identifying an effect indicated by the effect information 600. In the illustrated example, “space” is applied as the theme ID 601.

The music information 603 is information that defines music which is played during display of images. As illustrated in FIG. 4, the music information 603 may include not only information that identifies music and information that indicates a play time of the music but also additional information on the music.

The resource information 605 is information that defines images which are objects to be displayed with the use of the effect information 600. In the illustrated example, three images are defined, however, further more images may be defined.

The effect pattern information 607 is information that defines an effect pattern included in the effect information 600. For example, effect pattern information 607a defines an effect pattern identified as type=“012”. Effect pattern information 607b defines an effect pattern identified as type=“004”.

In the illustrated example, the effect pattern defines timings (show, start, end, hide) of start and end of image display and also defines a display region (trimmed range) of each image to be displayed. In a case of the effect pattern information 607a, an image of “id=0” is displayed by trimming a range of w (width)=0.8, h (height)=1 from a position of x=0.05, y=0.

Herein, in the effect pattern information 607, information on the above display region is defined in two ways, i.e., “3_{—}4” and “4_{—}3”. In the illustrated example, the information corresponds to the plurality of pieces of effect information set for the respective aspect ratios of the display section. In a case where the terminal device displays an image with the use of the effect information 600, the effect information selection section selects information on the display region which is defined for the aspect ratio of “3_{—}4” when the aspect ratio of the display section is 3:4. Meanwhile, in a case where the aspect ratio of the display section is 4:3, the effect information selection section selects information on the display region which is defined for the aspect ratio of “4_{—}3”.

Note that illustrated effect information is merely an example, and effect information can be written in other various forms in embodiments of the present disclosure. For example, effect information may be written in a form other than markup language. It is not always necessary that the plurality of pieces of effect information set for the respective aspect ratios of the display section are identified by a character string directly indicating an aspect ratio as described above, and an arbitrary identification method can be used. Different types of effect information may be selected as whole effect information (in the above example, the effect information 600) depending on an aspect ratio of the display section. Further, as described above, the aspect ratios of the display section are not limited to ratios having an inverse relationship such as 3:4 and 4:3. Therefore, in the above examples, effect information corresponding to other aspect ratios such as “9_{—}16” and “16_{—}9” may be defined.

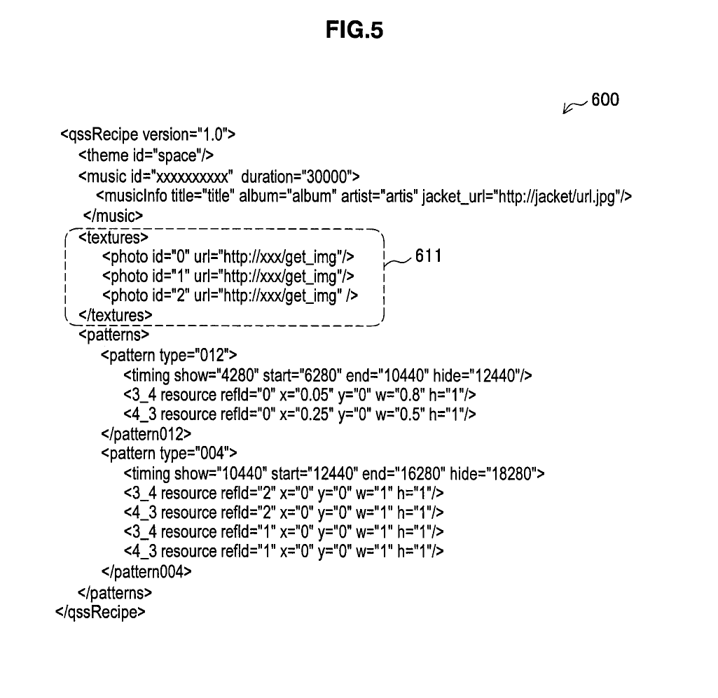

FIG. 5 is an illustration of another example of effect information in an embodiment of the present disclosure. In the illustrated example, as resource information 611, a command for acquiring an image is written instead of information on an address (such as uniform resource locator (URL)) of an image. The command can be provided, for example, as application program interface (API) in a service for storing images on a network. According to the above configuration, an image to be displayed can be dynamically replaced during display of the image.

Hereinafter, a specific example of an image displayable with the use of the above effect information will be described. Note that, in order to display the exemplified images, the effect information can include not only the information described in the above examples but also various types of information (e.g., information on animation display). Which information is specifically written is already known, for example, as a technology for displaying a slideshow described above, and therefore detailed description thereof will be herein omitted.

### 3. Display Example

### 3-1. Example of Change in Display Region

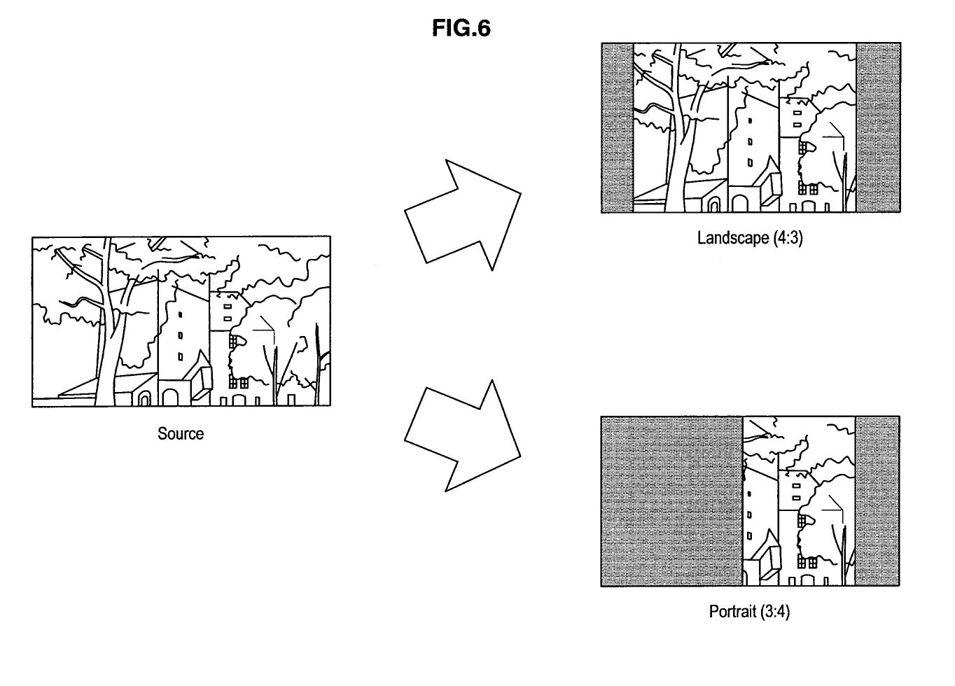

FIG. 6 to FIG. 9 are illustrations each of which describes an example of change in a display region of an image in an embodiment of the present disclosure. As illustrated in FIG. 6, in an embodiment of the present disclosure, different parts of an original image (Source) are trimmed as display regions in accordance with aspect ratios of a display section (in the illustrated example, Landscape (4:3) and Portrait (3:4)). The display regions trimmed herein can be selected by setting compositions appropriate for the respective aspect ratios in accordance with an aspect ratio and a feature value of each image with the use of, for example, the technology described in JP 2011-193125 A.

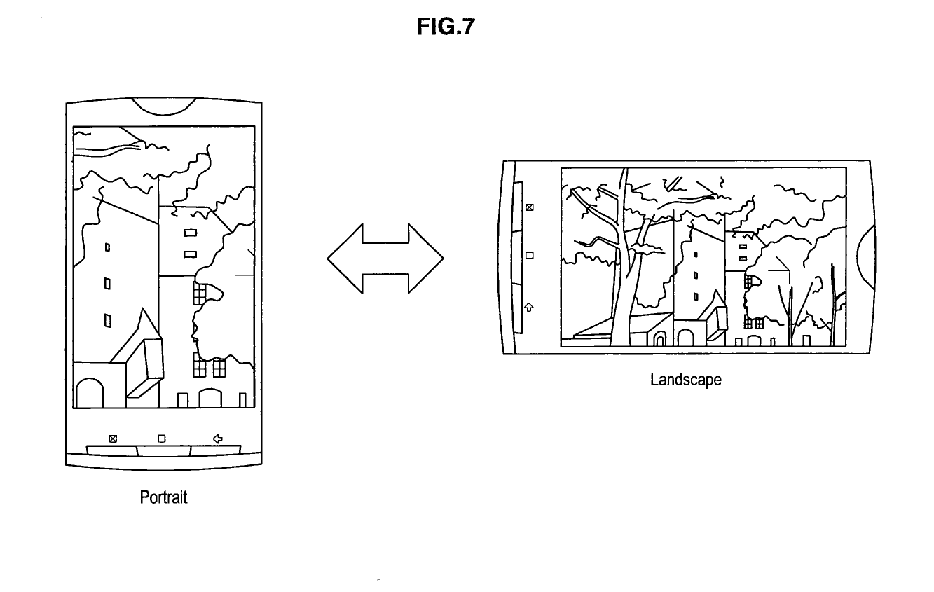

With this, as illustrated in FIG. 7, in a displayed image, appropriate (attractive) display regions are trimmed and are displayed in accordance with aspect ratios of the display section. At this time, because trimmed regions are completely different depending on a type of an image in some cases, an unpredictable effect that the same image looks like completely different images in accordance with the aspect ratios of the display section is also expected.

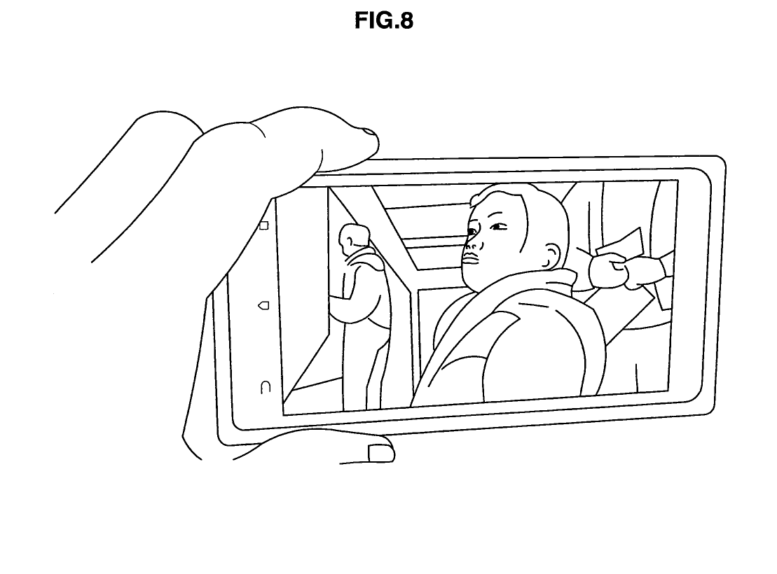

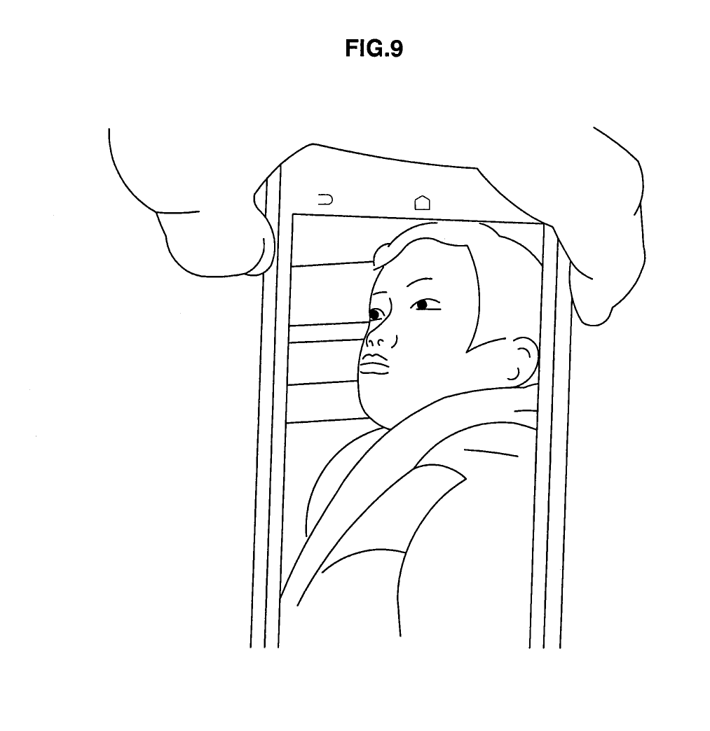

Also in examples illustrated in FIG. 8 and FIG. 9, parts trimmed as display regions are changed in accordance with aspect ratios of a display section. In this case, a subject (person) positioned at a center is the same, however, whether the subject including a background is trimmed or the subject is trimmed more largely is different in a case where the display section is vertically long or in a case where the display section is laterally long. Therefore, the display regions appropriate for the respective aspect ratios of the display section are trimmed.

### 3-2. Example of Change in Display Position

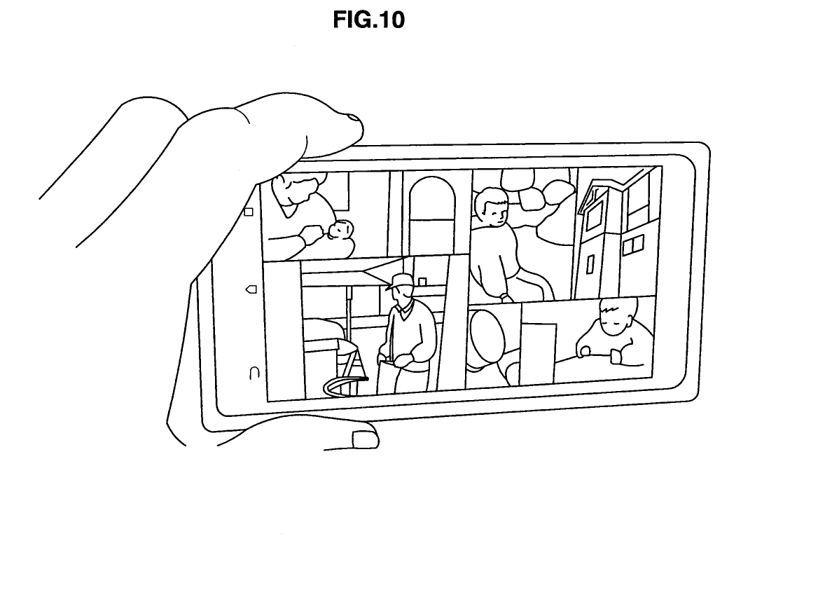

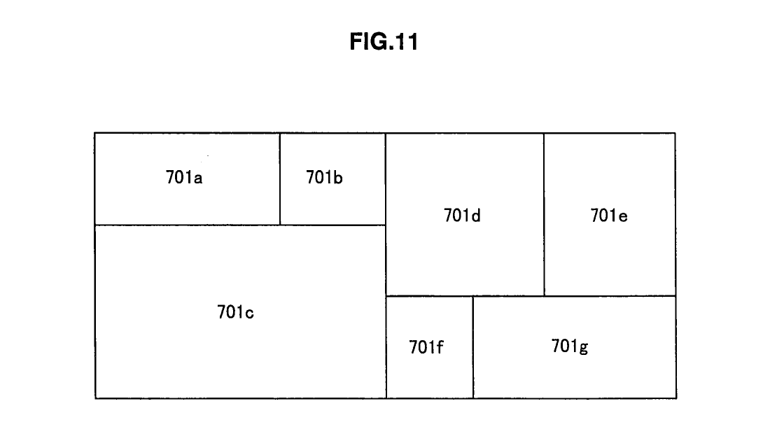

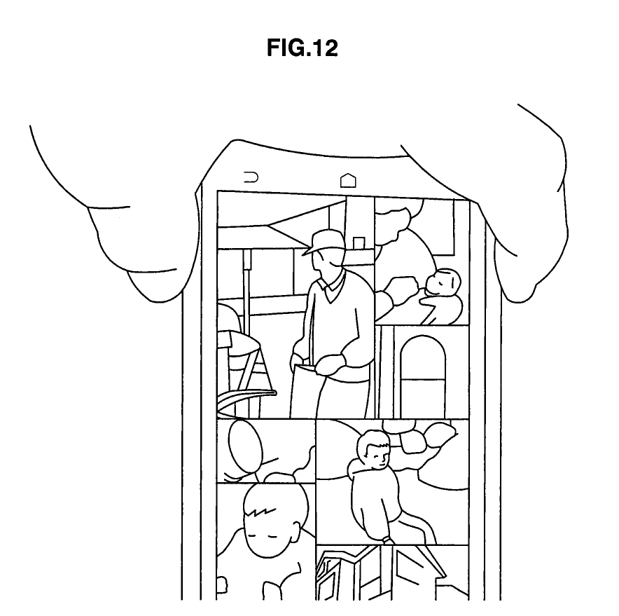

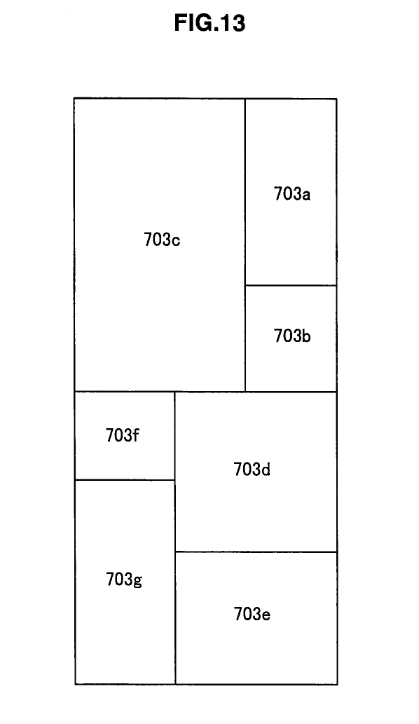

FIG. 10 to FIG. 13 are illustrations each of which describes an example of a change in display positions of images in an embodiment of the present disclosure. FIG. 10 and FIG. 11 illustrate examples where the images are displayed in a case where an aspect ratio of a display section is laterally long (landscape). In this case, images 701a to 701g are arranged in a lateral direction in the display section. FIG. 12 and FIG. 13 illustrate examples where the images are displayed in a case where the aspect ratio of the display section is vertically long (portrait). In this case, images 703a to 703g (same as the images 701a to 701g as original images) are arranged in a vertical direction in the display section. As such, in embodiments of the present disclosure, effect information includes information that defines arrangement positions of images and can be selected so that an arrangement direction of a plurality of images simultaneously displayed in the display section is closer to a longitudinal direction of the display section.

In the examples of FIG. 10 to FIG. 13, the display positions of the images are changed, and the display regions of the images are also changed. For example, in the examples of FIG. 10 and FIG. 11, the image 701a is displayed in a laterally long region, whereas, in the examples of FIG. 12 and FIG. 13, the image 703a (same as the image 701a as an original image) is displayed in a vertically long region. The display regions of the images can be selected in accordance with shapes of the regions in which the images are displayed in the same way as the above example of the change in the display regions. Note that the display positions of the images may be changed with or without the change in the display regions of the images (e.g., a case where the images are arranged with gaps).

### 3-3. Example of Change in Animation

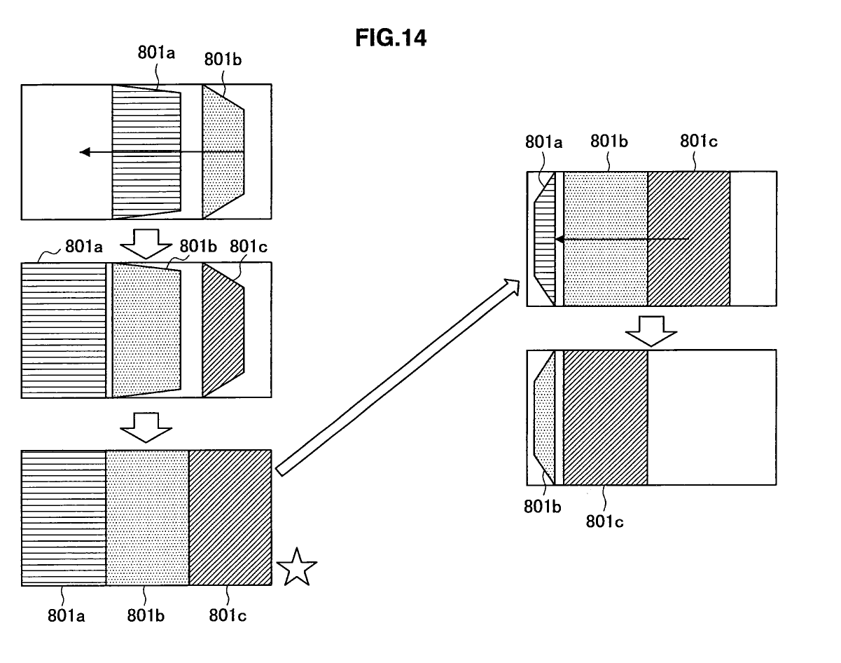

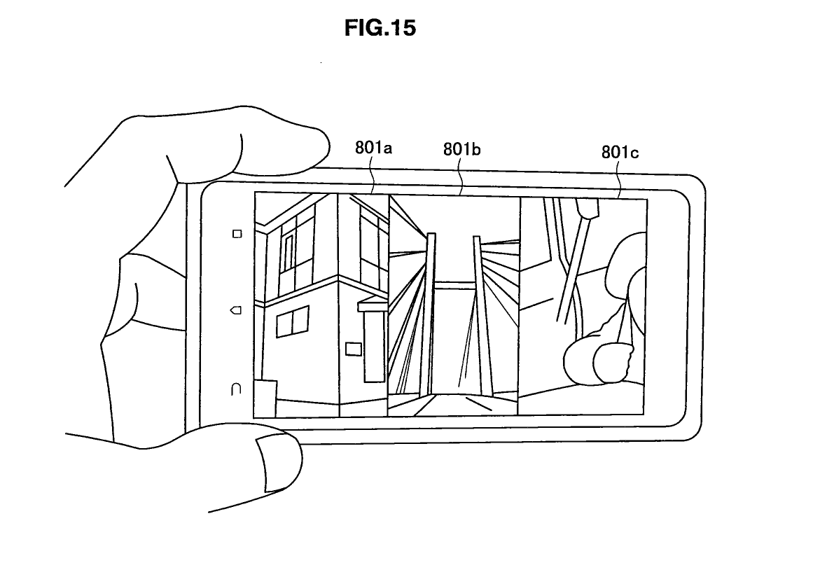

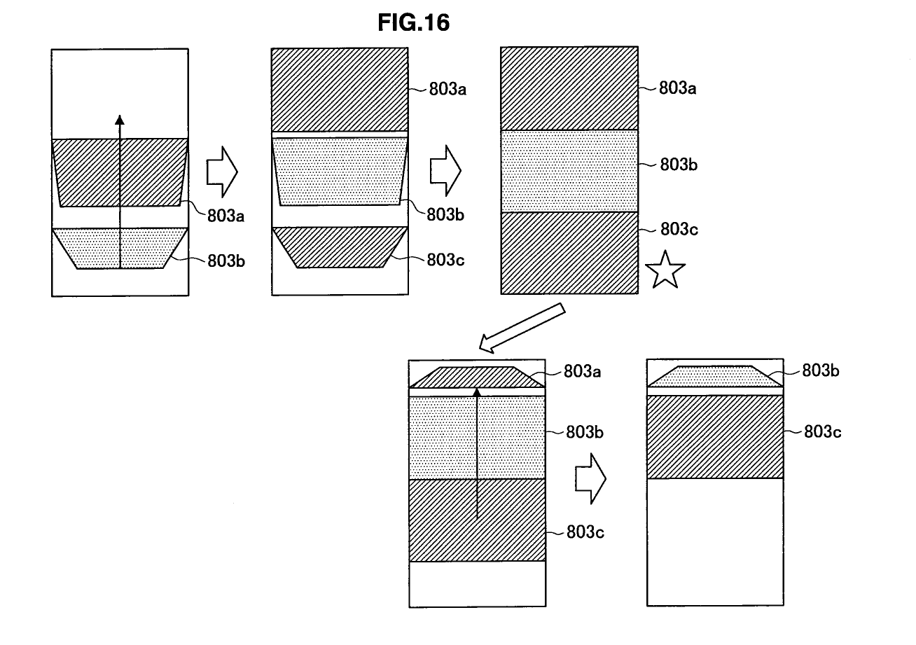

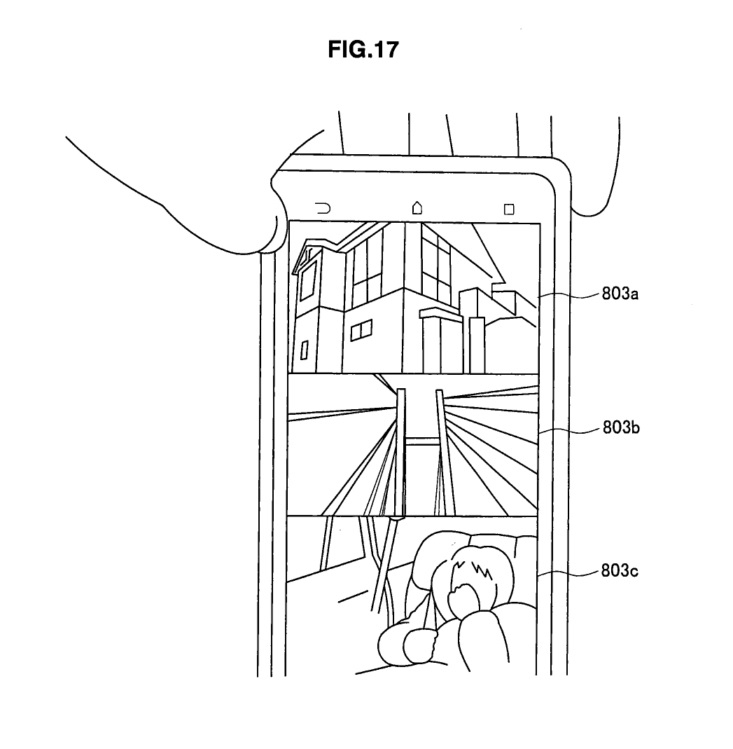

FIG. 14 to FIG. 17 are illustrations each of which describes an example of a change in animation of images in an embodiment of the present disclosure. FIG. 14 and FIG. 15 illustrate examples where the images are displayed in a case where an aspect ratio of a display section is laterally long (landscape). In this case, images 801a to 801c are moved and are displayed in a lateral direction in the display section. FIG. 16 and FIG. 17 illustrate examples where the images are displayed in a case where the aspect ratio of the display section is vertically long (portrait). In this case, images 803a to 803c (same as the images 801a to 801c as original images) are moved and are displayed in a vertical direction in the display section. As such, in embodiments of the present disclosure, effect information includes information that defines a moving direction of each image, and can be selected so that a moving direction of each image in the display section is closer to a longitudinal direction of the display section.

More specifically, in a case where the aspect ratio of the display section is laterally long (landscape), as illustrated in FIG. 14, the three images 801a to 801c sequentially appear from a right side of the display section while being rotated and are displayed while being arranged in a horizontal direction. A display example at this time is illustrated in FIG. 15. Thereafter, the images 801a to 801c sequentially disappear from a left side of the display section while being rotated.

In a case where the aspect ratio of the display section is vertically long (portrait), as illustrated in FIG. 16, the three images 803a to 803c sequentially appear from a lower side of the display section while being rotated and are displayed while being arranged in the horizontal direction. A display example at this time is illustrated in FIG. 17. Thereafter, the images 801a to 801c sequentially disappear from an upper side of the display section while being rotated.

Herein, as is clear from FIG. 15 and FIG. 17, animation of the images is changed, and the display regions of the images are also changed. For example, in the example of FIG. 15, the image 801a is displayed in a laterally long region, whereas, in the example of FIG. 17, the image 803a (same as the image 801a as an original image) is displayed in a vertically long region. The display regions of the images can be selected in accordance with shapes of the regions in which the images are displayed in the same way as the above example of the change in the display regions. Note that a change in animation of the images may be changed with or without the change in the display regions of the images (e.g., a case where the images are moved with gaps).

Note that, herein, a moving direction of each image in animation does not always the same as a long-side direction/short-side direction of the display section. In view of this, effect information include information that defines a moving speed in a case where images are displayed in the display section, and may be selected so that a speed component of the longitudinal direction in the display section become larger.

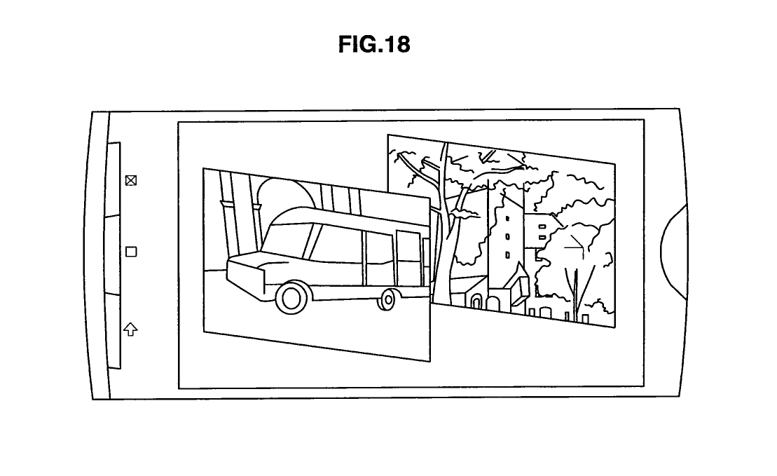

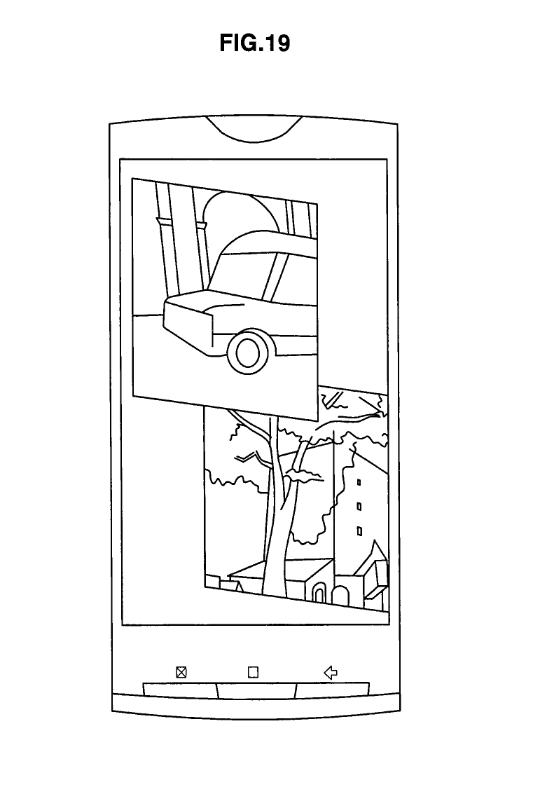

Further display examples are illustrated in FIG. 18 and FIG. 19. FIG. 18 illustrates an example where images are displayed in a case where the aspect ratio of the display section is laterally long, and FIG. 19 illustrates an example where images are displayed in a case where the aspect ratio of the display section is vertically long (portrait).

### 4. Example of Determination of Aspect Ratio

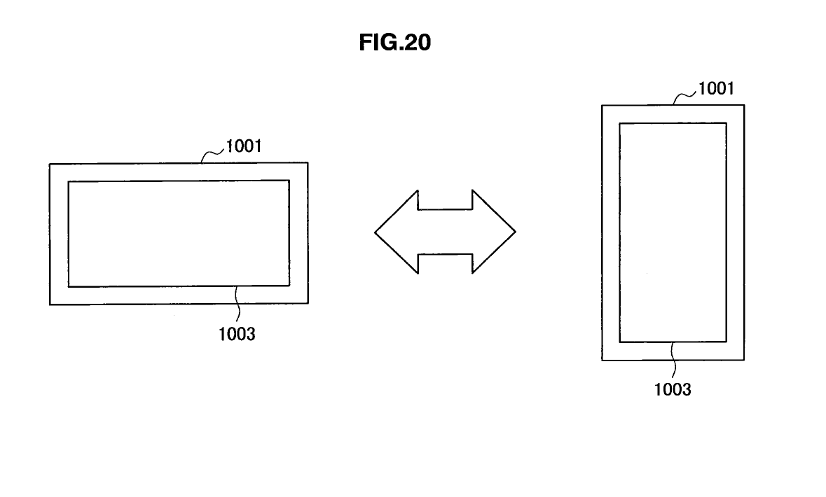

FIG. 20 is an illustration for describing a first example of determination of an aspect ratio in an embodiment of the present disclosure. In the illustrated example, an aspect ratio of a display section 1003 provided in a housing 1001 of a terminal device 1000 is determined on the basis of a direction in which the housing 1001 of the terminal device 1000 is held. That is, in a case where the housing 1001 is held in a vertically long direction, it is determined that the aspect ratio of the display section 1003 is also vertically long, and, in a case where the housing 1001 is held in a laterally long direction, it is determined that the aspect ratio of the display section 1003 is also laterally long. In this case, effect information includes effect information set for respective two aspect ratios having an inverse relationship.

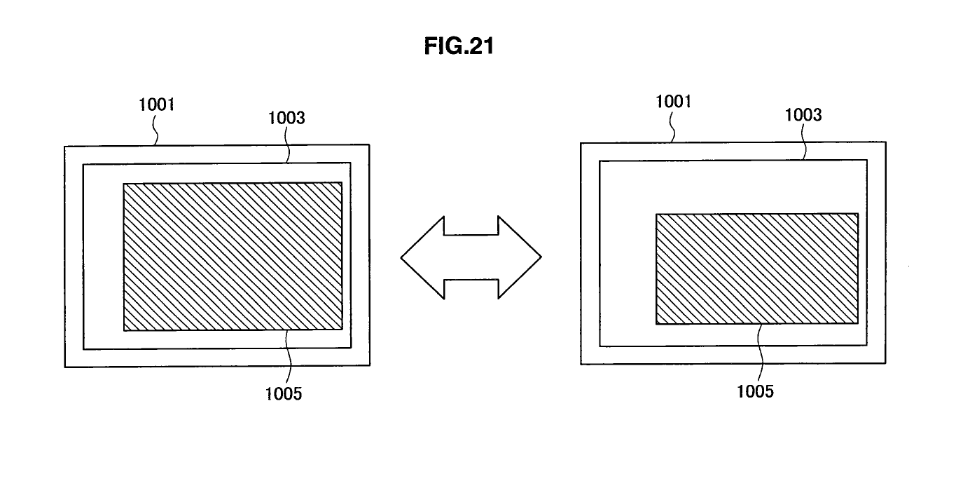

FIG. 21 is an illustration for describing a second example of determination of an aspect ratio in an embodiment of the present disclosure. In the illustrated example, the aspect ratio of the display section 1003 is determined on the basis of a size of a window 1005 displayed in the display section 1003 of the terminal device 1000. That is, in this case, the aspect ratio of the display section 1003 is interpreted as an aspect ratio of a window for use in an application that displays an image in the display section 1003.

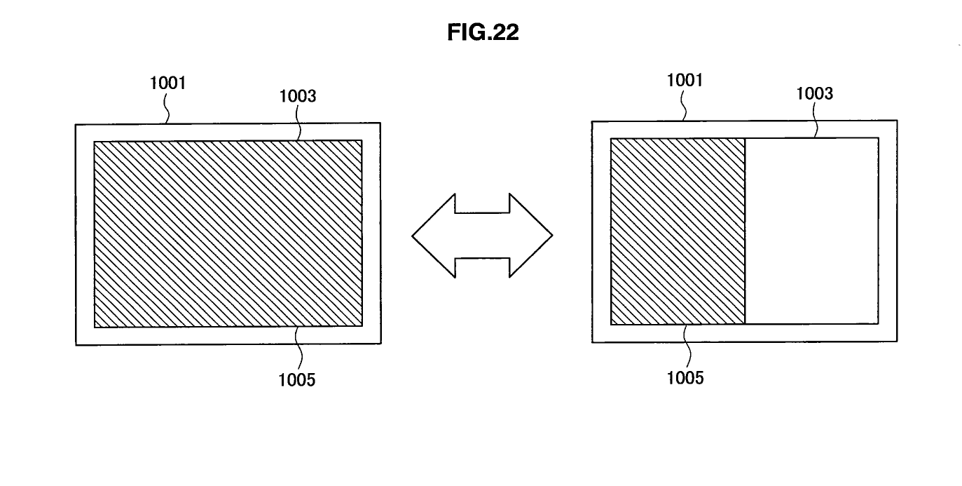

FIG. 22 is an illustration for describing a third example of determination of an aspect ratio in an embodiment of the present disclosure. In the illustrated example, the aspect ratio of the display section 1003 is determined on the basis of the size of the window 1005 displayed in the display section 1003 of the terminal device 1000. That is, in this case, the aspect ratio of the display section 1003 is interpreted as the aspect ratio of the window for use in an application that displays an image in the display section 1003. However, in the example of FIG. 22, the window is full screen display or is displayed on a divided region which is a half region of the display section 1003. In this case, a change in size of the window size 1005 is not always carried out by an operation of the change in the size of the window. In view of this, the aspect ratio determination section detects an operation, such as switching between full screen display and window display, division of the window, or display of sub-menus, and determines the aspect ratio of the display section 1003.

### 5. Example of Correction/Change

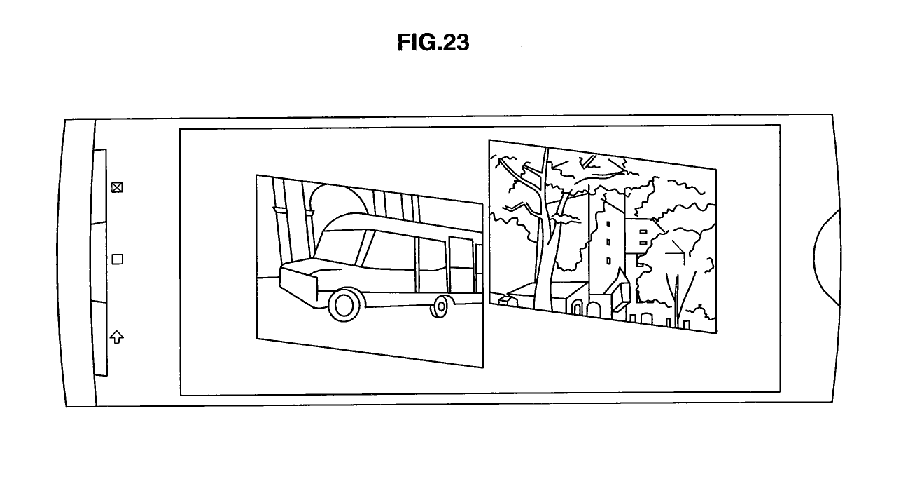

FIG. 23 is an illustration of an example of correction of effect information. In the illustrated example, an aspect ratio of a display section is laterally longer than that of the display section in FIG. 18. In a case where effect information corresponding to the above aspect ratio does not exist in effect information prepared in advance, the effect information selection section selects effect information (in this example, effect information of FIG. 18) of an aspect ratio closest to the aspect ratio of the display section. Based on the effect information, the correction/change section (functioning as the effect information correction section) may make correction on the basis of a difference between the aspect ratio in the effect information and the aspect ratio of the actual display section. Even if the aspect ratio is not excessive as illustrated in FIG. 23, fine adjustment of the effect information is usable because there is a case where the aspect ratio of the display section is not the aspect ratio (e.g., 4:3, 16:9) of the whole screen because of, for example, display of a menu bar.

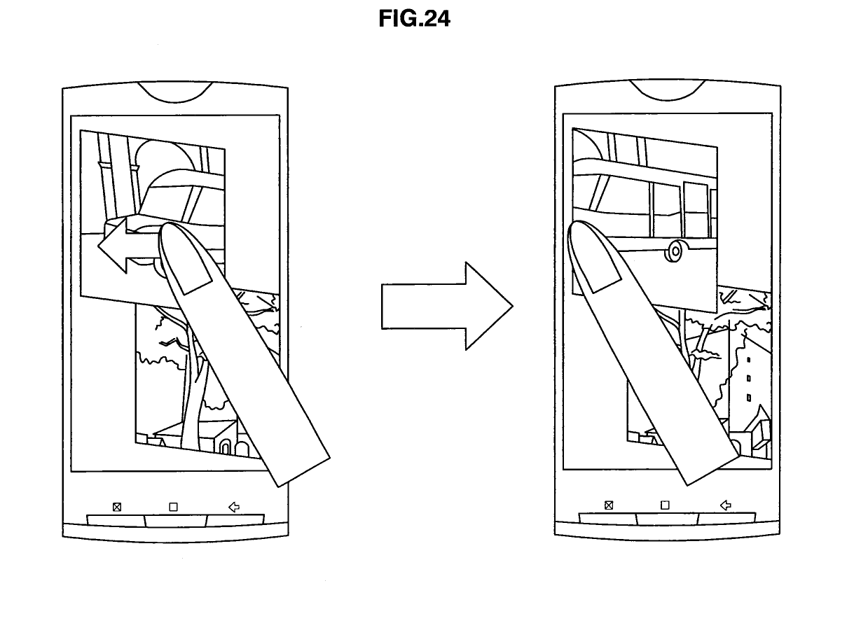

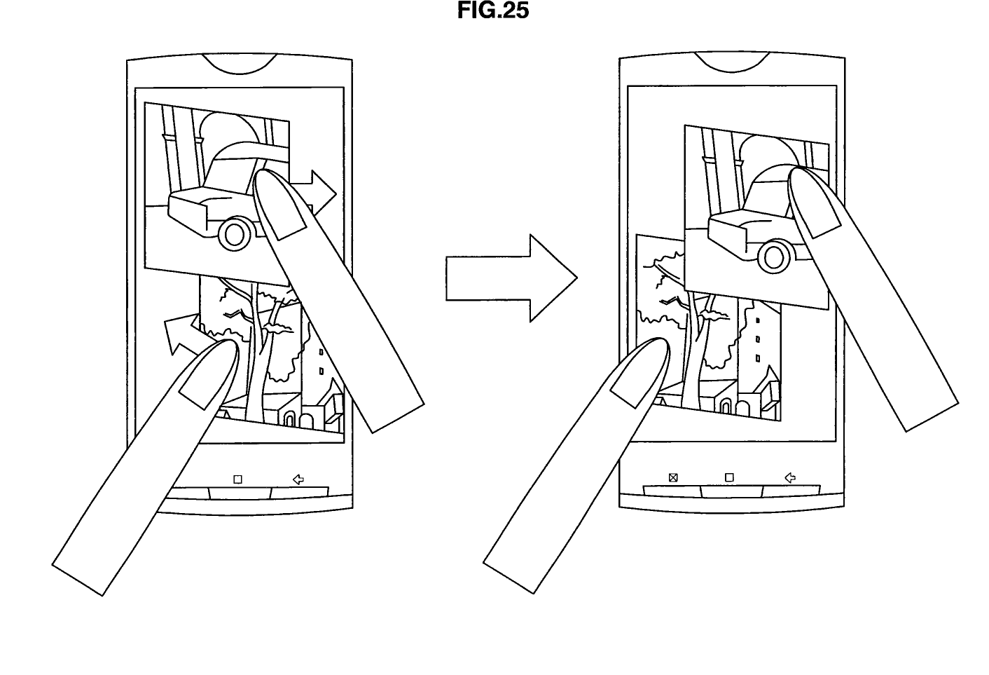

FIG. 24 is an illustration of an example where effect information is changed in response to an operation performed by a user. In the illustrated example, a display region in the display section is changed by an operation performed with respect to an image displayed in the display section (in an image of a bus displayed on a upper side, a displayed part is changed from a head of the bus to an intermediate part thereof). In this case, the correction/change section (functioning as an effect information change section) may store such change in the effect information. FIG. 25 is an illustration of an example where positions of images are changed in the same example of FIG. 24.

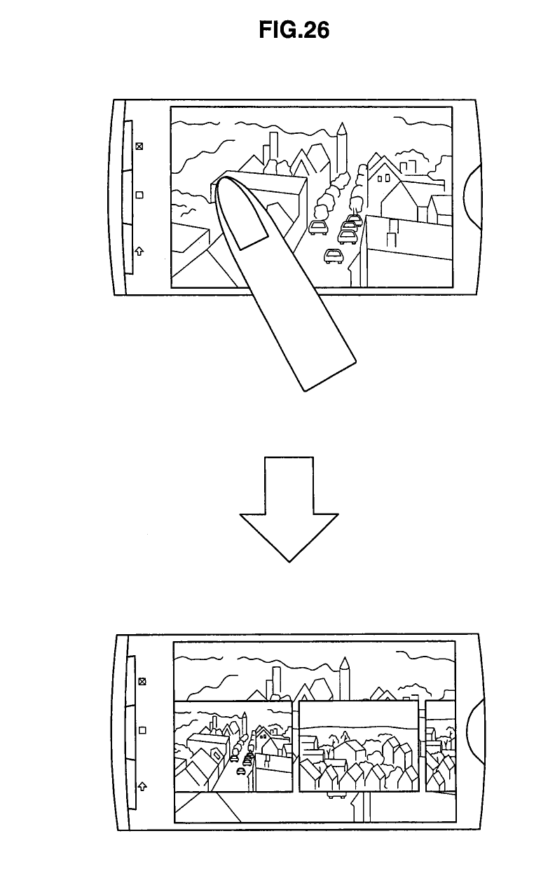

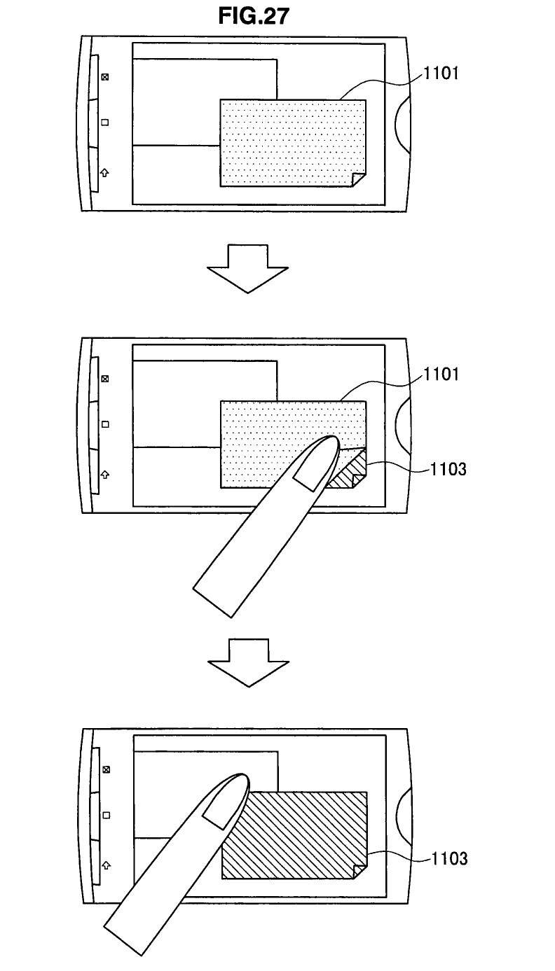

FIG. 26 is an illustration of an example where a representative image is changed in response to an operation performed by a user. In the illustrated example, the representative image displayed in a grouped images is changed by an operation performed with respect to an image displayed in the display section. In this case, the display control section displays a plurality of images in the display section in accordance with image selection information which defines that an image group grouped on a predetermined reference is replaced with a representative image of the image group and the representative image is displayed, and, in response to an operation performed by a user with respect to the representative image displayed in the display section, the display control section changes the representative image to another image in the image group and displays the another image. In this case, the correction/change section functions as an image selection information change section that changes the image selection information in accordance with the change of the representative image by the operation performed by the user. Note that the image selection information can be included in the effect information 190 in the examples of FIG. 1 to FIG. 3. In this case, as illustrated in FIG. 27, a user interface in which a changeable representative image 1101 is turned and changed to a new representative image 1103 may be displayed in the display section.

### 6. Hardware Configuration

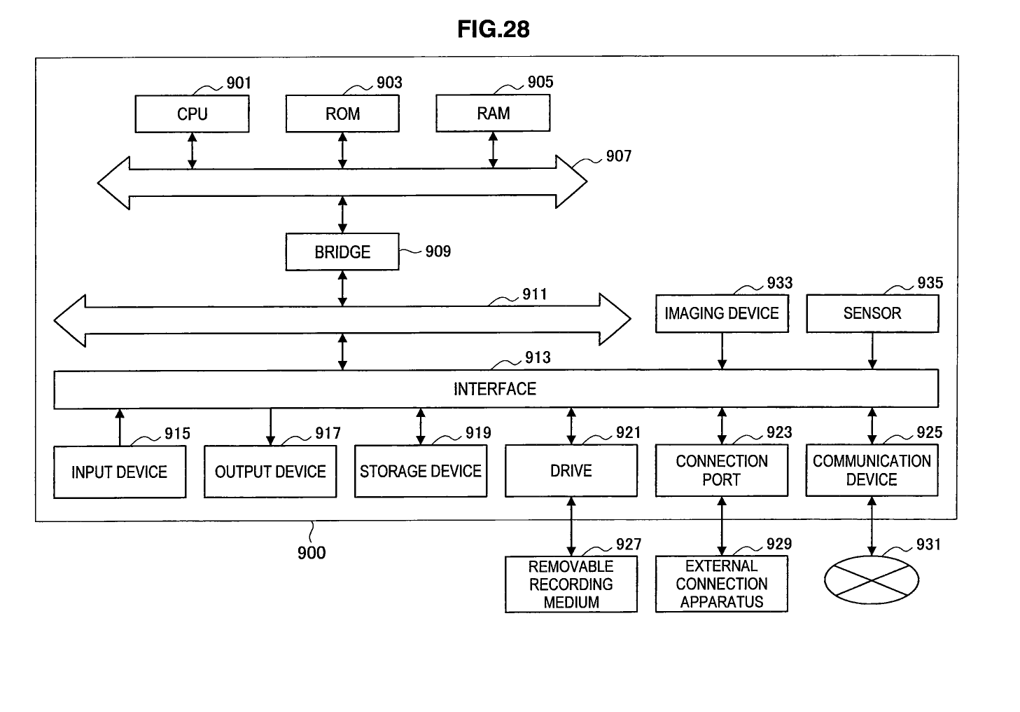

Next, with reference to FIG. 28, a hardware configuration of an information processing apparatus according to an embodiment of the present disclosure will be described. FIG. 28 is a block diagram for describing a hardware configuration of an information processing apparatus. An illustrated information processing apparatus 900 may realize, for example, the terminal device and the server in the above-described embodiments.

The information processing apparatus 900 includes a central processing unit (CPU) 901, read only memory (ROM) 903, and random access memory (RAM) 905. The information processing apparatus 900 may include a host bus 907, a bridge 909, an external bus 911, an interface 913, an input device 915, an output device 917, a storage device 919, a drive 921, a connection port 923, and a communication device 925. The information processing apparatus 900 may further include an imaging device 933 and a sensor 935 as necessary. The information processing apparatus 900 may include a processing circuit such as a digital signal processor (DSP) instead of or along with the CPU 901.

The CPU 901 functions as an arithmetic processing device and a control device, and controls all or a part of operations in the information processing apparatus 900 in accordance with various programs recorded on the ROM 903, the RAM 905, the storage device 919, or a removable recording medium 927. The ROM 903 stores, for example, a program and an operation parameter used by the CPU 901. The RAM 905 temporarily stores, for example, a program used when the CPU 901 operates, and a parameter varying as necessary while the CPU 901 is operating. The CPU 901, the ROM 903, and the RAM 905 are connected to each other by the host bus 907 including an internal bus such as a CPU bus. Furthermore, the host bus 907 is connected to the external bus 911 such as a peripheral component interconnect/interface (PCI) bus via the bridge 909.

The input device 915 is a device operated by a user such as a mouse, a keyboard, a touch panel, a button, a switch, and a lever. The input device 915 may be a remote control device that uses, for example, infrared radiation and another type of radiowaves. Alternatively, the input device 915 may be an external connection apparatus 929 such as a mobile phone that corresponds to an operation of the information processing apparatus 900. The input device 915 includes an input control circuit that generates input signals on the basis of information which is input by a user to output the generated input signals to the CPU 901. A user inputs various types of data and indicates a processing operation to the information processing apparatus 900 by operating the input device 915.

The output device 917 includes a device that can visually or audibly report acquired information to a user. The output device 917 may be, for example, a display device such as a liquid crystal display (LCD), a plasma display panel (PDP), and an organic electro-luminescence (EL) display, an audio output device such as a speaker and a headphone, and a printer. The output device 917 outputs a result obtained through a process performed by the information processing apparatus 900, in the form of video such as text and an image, or sounds such as voice and audio sounds.

The storage device 919 is a device for data storage that is an example of a storage unit of the information processing apparatus 900. The storage device 919 includes, for example, a magnetic storage device such as a hard disk drive (HDD), a semiconductor storage device, an optical storage device, or a magneto-optical storage device. The storage device 919 stores a program and various types of data executed by the CPU 901, various types of data acquired from an external apparatus, and the like.

The drive 921 is a reader/writer for the removable recording medium 927 such as a magnetic disk, an optical disc, a magneto-optical disk, and a semiconductor memory, and built in or externally attached to the information processing apparatus 900. The drive 921 reads out information recorded on the mounted removable recording medium 927, and outputs the information to the RAM 905. The drive 921 writes the record into the mounted removable recording medium 927.

The connection port 923 is a port for directly connecting a device to the information processing apparatus 900. The connection port 923 may be, for example, a universal serial bus (USB) port, an IEEE1394 port, and a small computer system interface (SCSI) port. The connection port 923 may also be, for example, an RS-232C port, an optical audio terminal, and a high-definition multimedia interface (HDMI) port. Various types of data may be exchanged between the information processing apparatus 900 and the external connection apparatus 929 by connecting the external connection apparatus 929 to the connection port 923.

The communication device 925 is a communication interface including, for example, a communication device for connection to a communication network 931. The communication device 925 may be, for example, a wired or wireless local area network (LAN), Bluetooth (registered trademark), or a communication card for a wireless USB (WUSB). The communication device 925 may also be, for example, a router for optical communication, a router for asymmetric digital subscriber line (ADSL), or a modem for various types of communication. For example, the communication device 925 transmits and receives signals in the Internet or transits signals to and receives signals from another communication device by using a predetermined protocol such as TCP/IP. The communication network 931 to which the communication device 925 connects is a network established through wired or wireless connection. The communication network 931 is, for example, the Internet, a home LAN, infrared communication, radio communication, or satellite communication.

The imaging device 933 is a device that shoots a real space by using an image sensor such as a charge coupled device (CCD) and a complementary metal oxide semiconductor (CMOS), and various members such as a lens for controlling image formation of a subject image onto the image sensor, and generates the shot image. The imaging device 933 may shoot a still image or a moving image.

The sensor 935 is various sensors such as an acceleration sensor, a gyro sensor, a geomagnetic sensor, an optical sensor, and a sound sensor. The sensor 935 acquires information regarding a state of the information processing apparatus 900 such as a posture of a housing of the information processing apparatus 900, and information regarding an environment surrounding the information processing apparatus 900 such as luminous intensity and noise around the information processing apparatus 900. The sensor 935 may include a global positioning system (GPS) sensor that receives GPS signals to measure latitude, longitude, and altitude of the apparatus.

As above, the example of the hardware configuration of the information processing apparatus 900 has been described. A general-purpose member may be used for each structural element, or hardware dedicated to a function of each structural element may also be used. The configuration may be changed as necessary in accordance with the state of the art at the time of working of the present disclosure.

### 7. Supplementary Explanation

Embodiments of the present disclosure can include, for example, the display control device (terminal device or server device) and the system, the display control method executed by the display control device or the system, the program for functioning the display control device, and the recording medium on which the program is recorded, all of which have been described above.

The preferred embodiments of the present invention have been described above with reference to the accompanying drawings, whilst the present invention is not limited to the above examples, of course. A person skilled in the art may find various alterations and modifications within the scope of the appended claims, and it should be understood that they will naturally come under the technical scope of the present invention.

Additionally, the present technology may also be configured as below.

(1)

A display control device, including:

a display control section that displays a plurality of images in a display section in time series in accordance with a plurality of pieces of effect information set for the plurality of images;

an aspect ratio determination section that determines an aspect ratio of the display section; and

an effect information selection section that selects, from the plurality of pieces of effect information set for respective aspect ratios, a piece of the effect information corresponding to the aspect ratio of the display section as effect information for use in display of the plurality of images.

(2)

The display control device according to (1), wherein:

the effect information includes information that defines a trimmed region in a case where each of the plurality of images is displayed in the display section; and

the plurality of pieces of effect information set for the respective aspect ratios include the plurality of pieces of effect information having the trimmed regions different from one another.

(3)

The display control device according to (2), wherein

the trimmed regions are determined in accordance with the aspect ratios and a feature value of each of the plurality of images.

(4)

The display control device according to any one of (1) to (3), wherein:

the plurality of pieces of effect information include information that defines a direction in which each of the plurality of images moves in a case where each of the plurality of images is displayed in the display section; and

the plurality of pieces of effect information set for the respective aspect ratios include the plurality of pieces of effect information having the directions different from one another.

(5)

The display control device according to (4), wherein

the effect information selection section selects effect information in which the direction closer to a longitudinal direction of the display section is defined.

(6)

The display control device according to any one of (1) to (5), wherein:

the effect information includes information that defines a speed at which each of the plurality of images moves in a case where each of the plurality of images is displayed in the display section; and

the plurality of pieces of effect information set for the respective aspect ratios include the plurality of pieces of effect information having the speeds different from one another.

(7)

The display control device according to (6), wherein

the effect information selection section selects effect information in which the speed whose component is larger in a longitudinal direction of the display section is defined.

(8)

The display control device according to any one of (1) to (7), wherein:

the effect information includes information that defines a position in a case where each of the plurality of images is displayed in the display section; and

the plurality of pieces of effect information set for the respective aspect ratios include the plurality of pieces of effect information having the positions different from one another.

(9)

The display control device according to (8), wherein:

the effect information includes information that defines the positions of the plurality of images simultaneously displayed in the display section; and

the effect information selection section selects the effect information so that an arrangement direction of the plurality of images simultaneously displayed in the display section is closer to a longitudinal direction of the display section.

(10)

The display control device according to any one of (1) to (9), further including

the display section.

(11)

The display control device according to (10), further including

a housing in which the display section is provided, wherein

the aspect ratio determination section determines the aspect ratio of the display section on the basis of a detection result of a holding direction of the housing held by a user.

(12)

The display control device according to (11), wherein

the plurality of pieces of effect information set for the respective aspect ratios include the pieces of effect information set for respective two aspect ratios having an inverse relationship.

(13)

The display control device according to any one of (1) to (9), further including

a communication section that communicates with an external device including the display section, wherein

the aspect ratio determination section determines the aspect ratio of the display section on the basis of information provided from the external device.

(14)

The display control device according to any one of (1) to (13), wherein

in a case where effect information corresponding to the aspect ratio of the display section does not exist, the effect information selection section selects a piece of the effect information set for an aspect ratio closest to the aspect ratio of the display section.

(15)

The display control device according to (14), further including

effect information correction section that corrects the selected effect information on the basis of a difference between the aspect ratio corresponding to the selected effect information and the aspect ratio of the display section.

(16)

The display control device according to any one of (1) to (15), wherein:

the display control section changes display of each of the plurality of images in response to an operation performed by a user with respect to each of the plurality of images displayed in the display section; and

the display control device further includes an effect information change section that changes, in accordance with the change in display of each of the plurality of images, information on the each of the plurality of images included in the selected effect information.

(17)

The display control device according to any one of (1) to (16), wherein:

the display control section
displays the plurality of images in the display section in accordance with image selection information which defines that an image group grouped on a predetermined reference is replaced with a representative image of the image group and the representative image is displayed, and
in response to an operation performed by a user with respect to the representative image displayed in the display section, changes the representative image to another image in the image group and displays the another image; and

the display control device further includes an image selection information change section that changes the image selection information in accordance with the change in the representative image.

(18)

A display control system, including:

a terminal device that displays a plurality of images in a display section in time series in accordance with a plurality of pieces of effect information set for the plurality of images; and

a server that generates the plurality of pieces of effect information for respective aspect ratios and provides the plurality of pieces of effect information to the terminal device, wherein

the terminal device determines an aspect ratio of the display section and selects, from the plurality of pieces of effect information set for the respective aspect ratios, a piece of the effect information corresponding to the aspect ratio of the display section as effect information for use in display of the plurality of images.

(19)

A display control method, including:

displaying a plurality of images in a display section in time series in accordance with a plurality of pieces of effect information set for the plurality of images;

determining an aspect ratio of the display section; and

selecting, from the plurality of pieces of effect information set for respective aspect ratios, a piece of the effect information corresponding to the aspect ratio of the display section as effect information for use in display of the plurality of images.

### REFERENCE SIGNS LIST

100, 200, 400 terminal device
120 display control section
140 effect information selection section
150 aspect ratio determination section
170 correction/change section
300 server
500 display device

1. A display control device, comprising:
a display control section that displays a plurality of images in a display section in time series in accordance with a plurality of pieces of effect information set for the plurality of images;
an aspect ratio determination section that determines an aspect ratio of the display section; and
an effect information selection section that selects, from the plurality of pieces of effect information set for respective aspect ratios, a piece of the effect information corresponding to the aspect ratio of the display section as effect information for use in display of the plurality of images.

2. The display control device according to claim 1, wherein:
the effect information includes information that defines a trimmed region in a case where each of the plurality of images is displayed in the display section; and
the plurality of pieces of effect information set for the respective aspect ratios include the plurality of pieces of effect information having the trimmed regions different from one another.

3. The display control device according to claim 2, wherein
the trimmed regions are determined in accordance with the aspect ratios and a feature value of each of the plurality of images.

4. The display control device according to claim 1, wherein:
the plurality of pieces of effect information include information that defines a direction in which each of the plurality of images moves in a case where each of the plurality of images is displayed in the display section; and
the plurality of pieces of effect information set for the respective aspect ratios include the plurality of pieces of effect information having the directions different from one another.

5. The display control device according to claim 4, wherein
the effect information selection section selects effect information in which the direction closer to a longitudinal direction of the display section is defined.

6. The display control device according to claim 1, wherein:
the effect information includes information that defines a speed at which each of the plurality of images moves in a case where each of the plurality of images is displayed in the display section; and
the plurality of pieces of effect information set for the respective aspect ratios include the plurality of pieces of effect information having the speeds different from one another.

7. The display control device according to claim 6, wherein
the effect information selection section selects effect information in which the speed whose component is larger in a longitudinal direction of the display section is defined.

8. The display control device according to claim 1, wherein:
the effect information includes information that defines a position in a case where each of the plurality of images is displayed in the display section; and
the plurality of pieces of effect information set for the respective aspect ratios include the plurality of pieces of effect information having the positions different from one another.

9. The display control device according to claim 8, wherein:
the effect information includes information that defines the positions of the plurality of images simultaneously displayed in the display section; and
the effect information selection section selects the effect information so that an arrangement direction of the plurality of images simultaneously displayed in the display section is closer to a longitudinal direction of the display section.

10. The display control device according to claim 1, further comprising
the display section.

11. The display control device according to claim 10, further comprising
a housing in which the display section is provided, wherein
the aspect ratio determination section determines the aspect ratio of the display section on the basis of a detection result of a holding direction of the housing held by a user.

12. The display control device according to claim 11, wherein
the plurality of pieces of effect information set for the respective aspect ratios include the pieces of effect information set for respective two aspect ratios having an inverse relationship.

13. The display control device according to claim 1, further comprising
a communication section that communicates with an external device including the display section, wherein
the aspect ratio determination section determines the aspect ratio of the display section on the basis of information provided from the external device.

14. The display control device according to claim 1, wherein
in a case where effect information corresponding to the aspect ratio of the display section does not exist, the effect information selection section selects a piece of the effect information set for an aspect ratio closest to the aspect ratio of the display section.

15. The display control device according to claim 14, further comprising
effect information correction section that corrects the selected effect information on the basis of a difference between the aspect ratio corresponding to the selected effect information and the aspect ratio of the display section.

16. The display control device according to claim 1, wherein:
the display control section changes display of each of the plurality of images in response to an operation performed by a user with respect to each of the plurality of images displayed in the display section; and
the display control device further includes an effect information change section that changes, in accordance with the change in display of each of the plurality of images, information on the each of the plurality of images included in the selected effect information.

17. The display control device according to claim 1, wherein:
the display control section
displays the plurality of images in the display section in accordance with image selection information which defines that an image group grouped on a predetermined reference is replaced with a representative image of the image group and the representative image is displayed, and
in response to an operation performed by a user with respect to the representative image displayed in the display section, changes the representative image to another image in the image group and displays the another image; and
the display control device further includes an image selection information change section that changes the image selection information in accordance with the change in the representative image.

18. A display control system, comprising:
a terminal device that displays a plurality of images in a display section in time series in accordance with a plurality of pieces of effect information set for the plurality of images; and
a server that generates the plurality of pieces of effect information for respective aspect ratios and provides the plurality of pieces of effect information to the terminal device, wherein
the terminal device determines an aspect ratio of the display section and selects, from the plurality of pieces of effect information set for the respective aspect ratios, a piece of the effect information corresponding to the aspect ratio of the display section as effect information for use in display of the plurality of images.

19. A display control method, comprising:
displaying a plurality of images in a display section in time series in accordance with a plurality of pieces of effect information set for the plurality of images;
determining an aspect ratio of the display section; and
selecting, from the plurality of pieces of effect information set for respective aspect ratios, a piece of the effect information corresponding to the aspect ratio of the display section as effect information for use in display of the plurality of images.
